(19) United States
(12) Patent Application Publication
(10) Pub. No.: US 2017/0065114 A1
(43) Pub. Date: Mar. 9, 2017

(54) PRAYER MAT WITH A BOW COUNTING SYSTEM

(71) Applicant: Abdulaziz Omar ALMUBARAK, Memphis, TN (US)

(72) Inventor: Abdulaziz Omar ALMUBARAK, Memphis, TN (US)

(21) Appl. No.: 14/847,805

(22) Filed: Sep. 8, 2015

(51) Int. Cl. A47G 27/02; G09B 19/00

(52) U.S. Cl. CPC A47G 27/0237; G09B 19/003

(57) ABSTRACT

A prayer mat that includes a tactile sensor secured to a lower surface of the prayer mat in proximity to the middle of the prayer mat configured to generate an output signal in response to detecting a pressure from the knees of a user, a bow count indicator configured to generate a visible signal, and processing circuitry configured to determine whether the output signal is valid by comparing the output signal to a predetermined signal level stored in a memory, receive the output signal from the sensor, update a count in response to determining that the output signal is valid, and activate the bow count indicator.

This application was prepared with financial support from the Saudia Arabian Cultural Mission, and in consideration therefore the present inventor has granted The Kingdom of Saudi Arabia a non-exclusive right to practice the present invention.

### BACKGROUND

In Islam, each person has to perform prayers five times a day. Each prayer must be performed at a predetermined time. The predetermined time is a function of geographical location and date. In addition, each prayer consists of specific steps that the person must perform. The steps are different for each predetermined time. Each prayer requires a prefixed number of bows to be performed.

According to the World Health Organization, between the years of 2000 to 2050, the number of people aged 60 years and over should increase from 605 million to around 2 billion. Muslims suffering from memory loss issues may be confused while performing the prayers while counting. Accordingly, it will be beneficial as recognized by the present inventor if a prayer mat is equipped with a bow counting system that helps the Muslim performs the prayers correctly and with peace of mind.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

The present disclosure relates to a prayer mat that comprises a tactile sensor secured to a lower surface of the prayer mat in proximity to the middle of the prayer mat configured to generate an output signal in response to detecting a pressure applied by knees of a user, a bow count indicator configured to generate a visible signal, a memory, and processing circuitry configured to receive the output signal from the tactile sensor, determine whether the output signal is valid by comparing the output signal to a predetermined signal level stored in the memory, update a count in response to determining that the output signal is valid, and activate the bow count indicator.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram that shows a prayer mat with a bow counting system according to one example;

FIG. 2 is a schematic diagram that shows a prayer mat with a bow counting system according to one example;

FIG. 3 is a schematic that shows the outputs of a ring counter according to one example;

FIG. 4 is a schematic showing a Johnson ring counter according to one example;

FIG. 5 is a table that shows the output of the Johnson ring counter according to one example;

FIG. 6 is a logic diagram showing the integrated circuit used in the prayer mat according to one example;

FIG. 7 is a schematic showing the tactile sensor according to one example;

FIG. 8 is a schematic of a bow counting system according to one example;

FIG. 9 is a flow chart that shows the operation of the bow counting system according to one example;

FIG. 10 is an exemplary block diagram of a server according to one example;

FIG. 11 is an exemplary block diagram of a data processing system according to one example; and

FIG. 12 is an exemplary block diagram of a central processing unit according to one example.

### DETAILED DESCRIPTION

Referring now to the drawings, wherein like reference numerals designate identical or corresponding parts throughout several views, the following description relates to a prayer mat with a bow counting system and associated methodology for determining when a user is performing a prayer and counting the number of bows performed by the user.

There are five prayers that must be performed by any Muslim every day. Each prayer is performed at a predetermined time of the day. The prayer times in Islam depend on the condition of the sun and geography. Hence, the prayer times vary at different locations on the earth. A morning prayer is performed right before sunrise. Following the morning prayer is a noon prayer which is followed by an afternoon prayer, followed by a sunset prayer, and finally an evening prayer. One difference between each prayer is the number of bows that have to be performed. That is, each prayer has a required number of bows that have to be performed. For example, the required number of bows is two for the morning prayers, four for the noon and afternoon prayers, three for the sunset prayers, and four for the evening prayers.

A major common factor between all prayers performed by all Muslims around the world is the prayer mat. Every Muslim must perform their daily prayers on a clean surface, and since all floors tend to become dirty over time, the use of a prayer mat becomes very essential.

Over the years, technology have evolved and aided religion practices to help reach a wider range of worshipers. The use of speakers in mosques have been highly adapted throughout every mosque to amplify the sound. In addition, the use of green light emitting diodes (LEDs) is sometimes implemented to help guide the worshiper to the closest mosque. Any new technology that aids the worshiper to perform his daily prayer tasks without being a distraction, is more than welcomed in the Islamic religion.

Prayer is necessary for all capable Muslims above the age of 11. As worshipers start learning how to pray, they sometimes confuse the number of bows that must be performed during which prayer of the day. The confusion may cause a worshiper to lose focus on the actual prayer and try to remember how many bows have to be performed. The confusion not only occurs with new worshipers, but with Muslim's who have one type or another of a memory slip. The memory slip usually occurs in the middle of a prayer where the person may forget which bow he is performing. The worshiper may also forget how many bows he has to perform. The confusion may cause loss of focus as the person tries to remember how many bows are left. Sometimes, the confusion may cause the person performing the prayer to start the prayer from the beginning, as the person may be unsatisfied with the quality of the prayer.

The prayer mat of the present disclosure is an aid to new worshipers and the aging population with loss of memory issues to better perform their daily prayers. The prayer mat described herein may help them focus on performing the actual prayer and be in tune with God rather than trying to remember how many bows have performed, or how many bows are still left.

In one embodiment, the prayer mat described herein may be used to help kids that are younger than the age of 11 by indicating whether they have completed each prayer by showing the number of bows performed. The prayer mat shows the kids when they have completed the required number of bows. By teaching them the correct number of bows at a young age, it helps them to perform their daily prayers easier as they grow older.

An advantage of the prayer mat described herein is that it does not alter the primary goal of traditional prayer mats. The traditional prayer mats have been around for hundreds of years with slight modifications over the years in term of cosmetic design. Thus, the primary goal is a slick and concealed design to avoid any distraction to the worshipers.

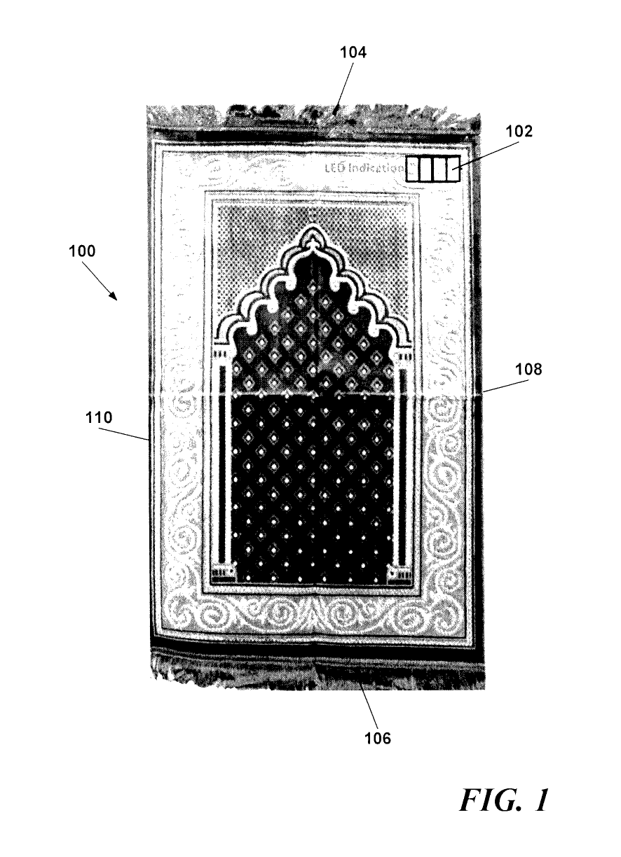

FIG. 1 is a schematic diagram that shows a prayer mat with a bow counting system according to one example. The prayer mat 100 has a short upper side 104 and a short lower side 106. The short upper side 104 and the short lower side 106 are parallel to each other. A first long side 108 and a second long side 110 couple the short upper and lower sides. The first long side 108 and the second long side 110 are parallel to each other. The prayer mat 100 has a top exposed surface for receiving the user and a lower surface. The prayer mat 100 may include a bow count indicator 102 that indicates the number of bows performed by the user. In one embodiment, the bow count indicator 102 may include light emitting diodes. The bow count indicator 102 may be positioned near the short upper side 104 of the prayer mat 100 to be in the sight of view of the user. The prayer mat 100 may also include a power source such as a battery. The battery may be a rechargeable battery. In one embodiment, the prayer mat 100 may also include a compass. The compass may be an electronic compass or a mercury compass. The compass may be used by the user to determine Mecca direction.

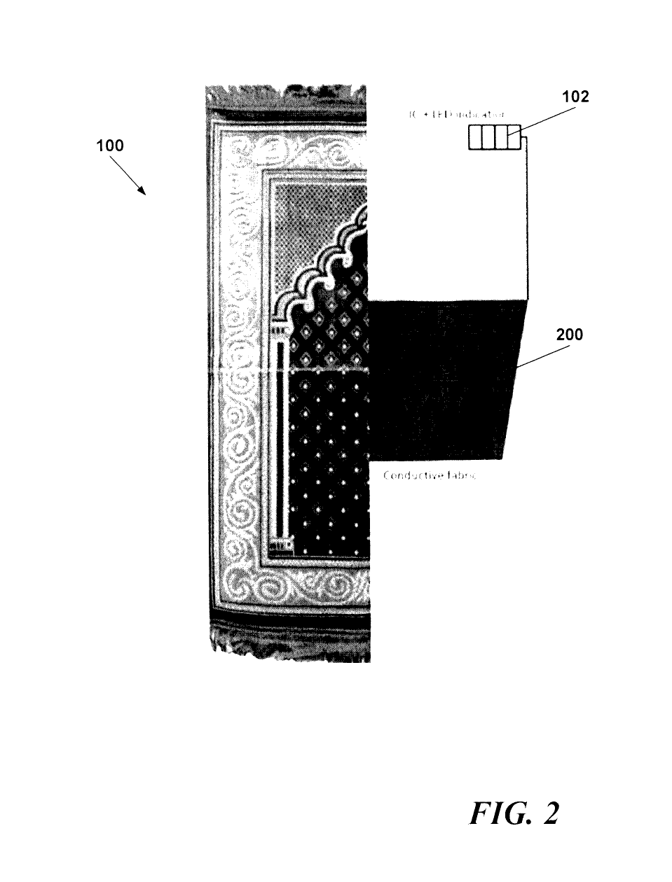

FIG. 2 is a schematic diagram that shows the prayer mat 100 according to one example. In one embodiment, a tactile sensor 200 may be positioned on the lower surface of the prayer mat 100. The tactile sensor 200 may be integrated with the lower surface of the prayer mat 100. In one embodiment, the tactile sensor 200 may be positioned between the lower surface and the top surface. FIG. 2 shows a cross section of view the prayer mat 100 that shows the placement of the tactile sensor 200. The tactile sensor 200 detects pressure applied by the knees of the user while praying. The tactile sensor 200 may be connected to processing circuitry through a wire. The wire connecting the tactile sensor 200 to the input of the processing circuitry may be fixed to either one of the long sides of the prayer mat 100. The processing circuitry may be an integrated circuit, a microcontroller, a counter, or the like. In one embodiment, the connection between the tactile sensor 200 and the bow count indicator 102 may be wireless. The wireless connection may be based on any technology known to those skilled in the art such as Bluetooth technology and Wifi technology. The battery powers the processing circuitry, the tactile sensor 200, and the bow count indicator 102. In one embodiment, the tactile sensor 200 may include conductive fabrics that act as a switch input to a bow counter. That is, the tactile sensor 200 acts as an input to the bow counter.

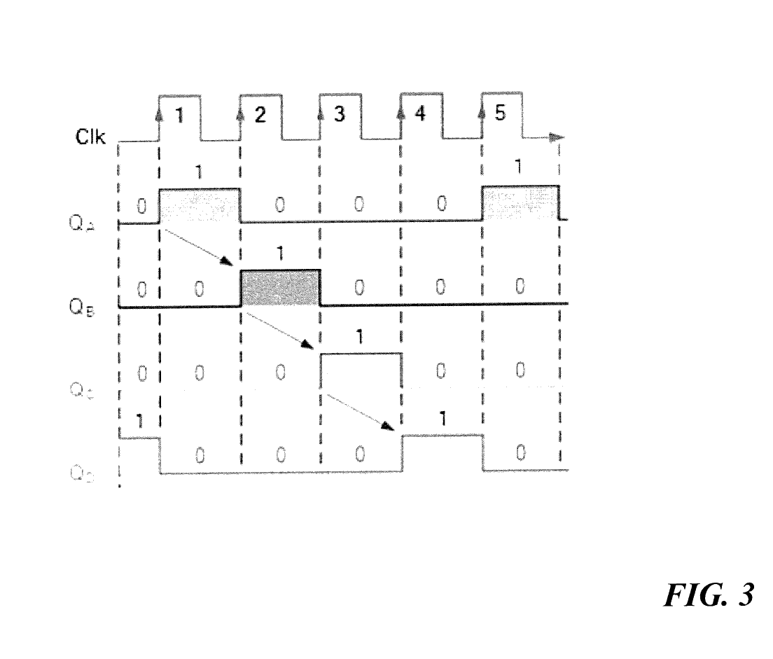

FIG. 3 is a schematic that shows the outputs of a ring counter according to one example. In one embodiment, the prayer mat 100 may use a ring counter. The ring counter is a counter that uses circular shift registers. The output of the last shift register is fed to the input of the first register. The ring counter may be a D flip flop shift counter where the bit is shifted from one place to the next. The outputs of the ring counter may be connected to the LEDs of the bow count indicator 102. As one output is high at any given time, one LED of the LED's included in the bow count indicator 102 may be ON to indicate the bow count. In FIG. 3, the “Clk” represents the input and Q_{A}, Q_{B}, Q_{C}, Q_{D} represents the outputs of the ring counter. The input may be the signal received from the tactile sensor 200. In one embodiment, the ring counter may include four registers. Thus, the ring counter may count up to four where four represents the maximum number of required bows. In other embodiments, the ring counter may include five or more shift registers to count recommended additional bows that may be performed by the user.

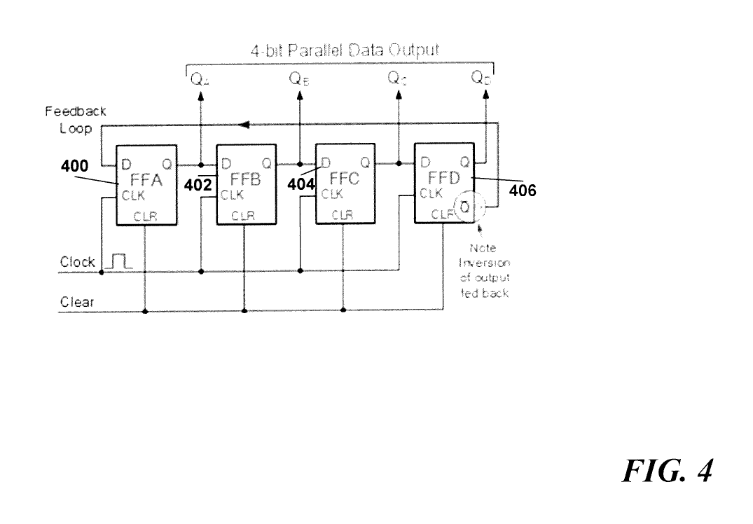

FIG. 4 is a schematic showing a Johnson ring counter according to one example. In one embodiment, the prayer mat 100 may use a Johnson ring counter. The Johnson ring counter is similar to the ring counter, as would be understood by one of ordinary skill in the art, in which it uses D flip flops. However, the connection from the last shift register is inverted and then fed to the input of the first register. FIG. 4 shows a 4-bit Johnson counter. The outputs of the Johnson ring counter may be all high at the same time. As shown in FIG. 4, the connection of the forth flip flop is inversely looped back to the first flip flop. FIG. 4 shows a first D Flip Flop 400, a second D Flip Flop 402, a third D flip flop 404, and a fourth flip flop 406 with output Q_{A}, Q_{B}, Q_{C}, and Q_{D} respectively. In one embodiment, the Johnson counter may be a 4 or more bit counter.

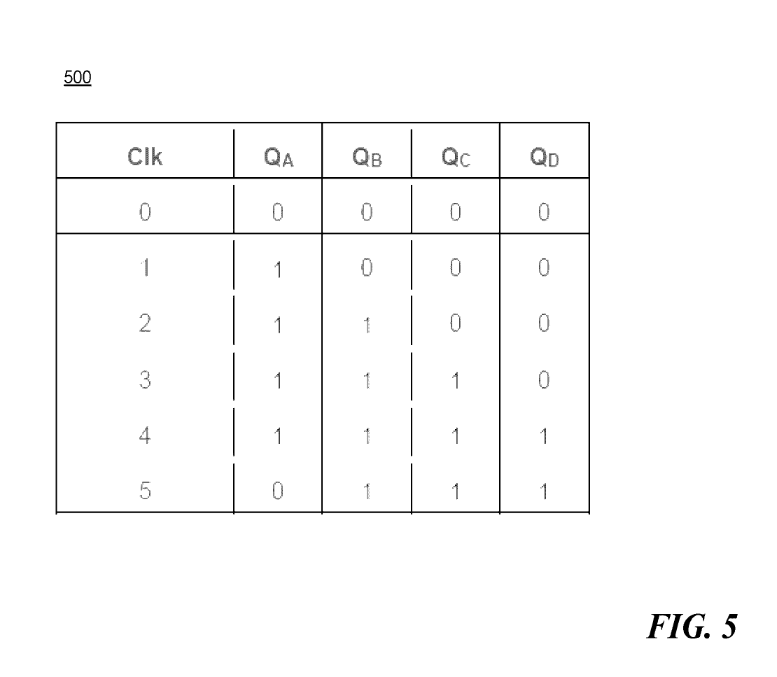

FIG. 5 is a table that shows the output of the Johnson ring counter according to one example. In FIG. 5, “Clk” represents the input while Q_{A}, Q_{B}, Q_{C}, Q_{D} represents the outputs. The input may be the signal received from the tactile sensor 200. As shown in FIG. 5, Q_{A}, Q_{B}, Q_{C}, Q_{D} are actively high when the Clk is on its fourth cycle. The input of the Johnson ring counter is the output of the tactile sensor 200.

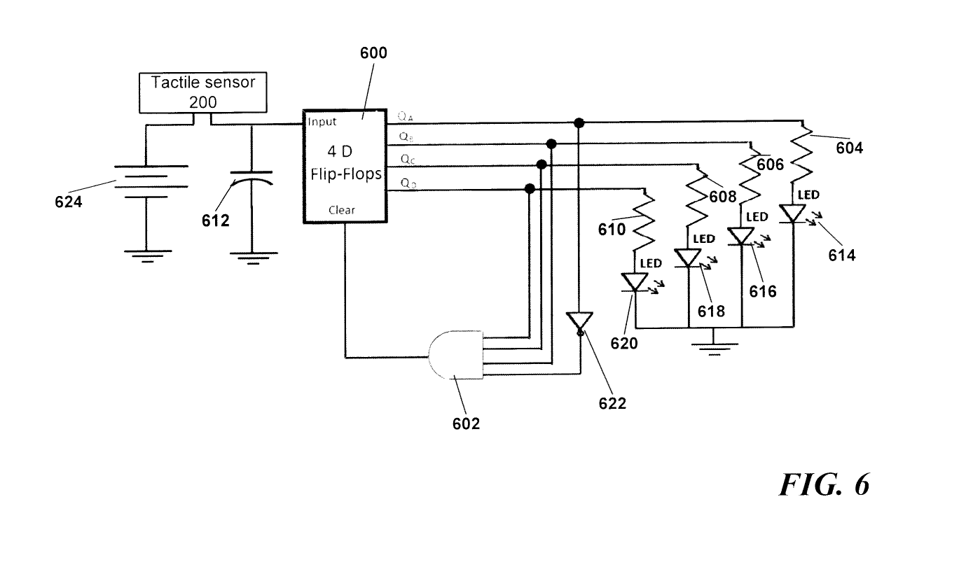

FIG. 6 is a logic diagram showing an integrated circuit used in the prayer mat 100 according to one example. In one embodiment, the integrated circuit may include 4 D flip flops 600. A single 7474 IC consists of 2 flip flops so two 7474ICs may be used as 600. The bow counting system also includes one AND gate 602, resistors 604, 606, 608, 610, and a capacitor 612 used as a delay input. The AND gate 602 may be a 7405 IC. The resistors 604, 606, 608, 610 are current limiting resistors and their values may be calculated depending on the power supply from the battery as would be understood by one of ordinary skills in the art. In FIG. 6, the bow count indicator 102 includes four LEDs 614, 616, 618, 620. FIG. 6 shows the connection from the output of the 4 D flip flops 600 to the four LEDs 614, 616, 618, 620. The input of the flip-flops is connected to the tactile sensor 200. The power for the circuitry is provided by the battery 624. An inverter 622 is connected to one input of the AND gate 602. The inverter 622 may be a 4049 CMOS chip.

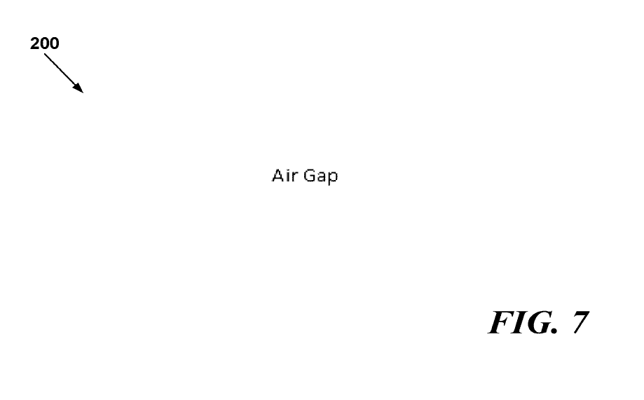

FIG. 7 is a schematic that shows the tactile sensor according to one example. In one embodiment, the tactile sensor 200 is made of a conductive fabric acting as a switch to provide a signal to the counter. The tactile sensor 200 needs to be placed discreetly in a way that it functions as a push button switch. Conductive fabrics may be used to perform a push button function discreetly. However, using a conductive fabric in such a large area may results in input errors. As shown in FIG. 7 in order to overcome the possibility of input errors, an air gap is included between the two inductive sheets. The conductive fabric is a fabric that can conduct electricity. The conductive fabrics may include conductor fibers, which are coated with electrically conductive elements such as carbon, nickel, copper, gold or the like.

The tactile sensor 200 detects when the knees of the user touches the prayer mat 100 and provides an output signal to the processing circuitry. The output signal may be amplified using an amplifier so that the processing circuitry can read it. The tactile sensor 200 may have an analog or digital output depending on the specification of the processing circuitry.

The placement of the tactile sensor 200 may start at ⅓ the total distance from the short upper side 104 of the prayer mat 100 and ends at ⅓ of the prayer mat 100 from the short lower side 106 of the prayer mat 100. The tactile sensor 200 may have a surface area equals to ⅓ of the surface are of the prayer mat 100 to achieve good contact. In one embodiment, the placement of the tactile sensor 200 may be adjustable corresponding to the height of the user.

In one embodiment, the tactile sensor 200 may include a bottom layer and a top layer. An array of pressure sensing elements may be placed between the bottom layer and the top layer. The pressure sensing elements may be electromechanical pressure sensors or other types of sensors as would be recognized by one of ordinary skill in the art. The pressure sensing elements may include pressure sensitive resistors. The pressure sensitive resistors may be that disclosed in U.S. Pat. No. 5,948,990 entitled PRESSURE SENSITIVE RESISTOR, the entire disclosure of which is incorporated herein by reference. The voltage output of the pressure sensitive resistor varies with applied pressure. The processing circuitry may use the voltage output to determine whether the applied pressure was caused by the knees of the user 104. For example, the processing circuitry may compare an output voltage with a predetermined voltage. The predetermined voltage may correspond to the minimum voltage that may be due to a pressure from the knees of the user. This feature is beneficial to minimize of erroneous output signals from the tactile sensor 200 that may be caused by objects other than the knees of the user.

The prayer mat 100 may turn off automatically after detecting the predetermined number of bows by the tactile sensor 200. In one embodiment, a delay timer may be used to turn off the light indicator after a suitable period. In one embodiment, the predetermined number of bows may be equal to four. In other embodiments, the predetermined number of bows may be based on the prayer time. Thus, the predetermined number of bows may be equal to the required number of bows. In other embodiments, the predetermined number of bows may be fixed by the user at the beginning of each prayer. In other embodiments, the predetermined number of bows may be greater than the required number of bows.

The bow count indicator 102 has the advantage of indicating to the user the number of performed bows in a discreet manner to avoid any distractions while praying. The bow count indicator 102 may include small LED lights. The LED lights receive an input signal from the processing circuitry. For example, the LED lights may receive the input signal from the Johnson ring counter's outputs. In one embodiment, the bow count indicator 102 is placed near short upper side 104. In one embodiment, the bow count indicator 102 may be placed on the long sides of the prayer mat 100. For example, the bow count indicator 102 may be fixed to the prayer mat 100 using clips. Thus, the user may change the position of the bow count indicator 102. The bow count indicator 102 may be positioned anywhere in the field of view of the user as would be understood by one of ordinary skill in the art. In one embodiment, the bow count indicator 102 may include four LEDs that correspond to the maximum required number of bows. In other embodiments, the bow count indicator 102 may include four or more LEDs to indicate the count for the recommended additional bows. In one embodiment, the LEDs used to indicate the required number of bows may have a different color than those used to indicate the number of additional bows that may be performed by the user.

In one embodiment, the bow count indicator 102 may include an additional LED light that is activated when the user has performed the required number of bows. For example, the bow count indicator 102 may include four LEDs to indicate the count and a fifth LED to indicate that the required number of bows has been performed. Once the processing circuitry determines that the count is equal to the required number of bows, the fifth LED is activated. In one embodiment, the payer mat 100 may also include a speaker. The processing circuitry may generate a sound through the speaker to indicate that the required number of bows has been performed.

In one embodiment, the bow count indicator 102 may include a single LED. The single LED is activated when the count is equal to the required number of bows. That is, the processing circuitry may compare the count with the required number of bows. In response to determining that the count is equal to the required number of bows, the processing circuitry generates a signal to activate the single LED. Once the single LED is activated, the user is informed that the required number of bows has been completed.

In one embodiment, the bow count indicator 102 may be a one-digit display. The one digit display may be an LED display. The one digit display may receive the input from a CMOS4518 with a binary-coded decimal (BCD) to 7-segment decoder such as 4511IC. The bow count indicator 102 may be configured to display the count, which corresponds to the number of bows performed by the user. In other embodiments, the bow count indicator may display a remaining number of bows that the user must perform. The processing circuitry determines the remaining number of bows based on the count and the required number of bows. In one embodiment, the bow count indicator 102 may indicate the number of bows done and the number of bows remaining. For example, the bow count indicator 102 may include two one-digit displays to indicate both the number of bows performed and the number of bows remaining. In an embodiment, the one-digit display may display a character indicating that count is equal to the required number of bows. For example, the one-digit display could present or flash and “8” digit. As the required number of bows generally would not be as high as eight, the presentation or flashing of the “8” digit would indicate to the user that the required number of bows has been achieved.

In one embodiment, the tactile sensor 200, the bow count indicator 102, and the processing circuitry may be detachable from the prayer mat 100. In other words, the bow count system may be added to any prayer mat the user already owns.

In one embodiment, the prayer mat 100 may further include communication circuitry and location detection circuitry. For example, Global Positioning System (GPS) circuitry may be included within the prayer mat 100 to detect the location as would be understood by one of ordinary skill in the art. The processing circuitry based on the current time, the current date, and the location may determine the required number of bows. The processing circuitry may connect to a server or a computer to determine an exact prayer time and the required number of bows. In other embodiments, the processing circuitry may determine the required number of bows based on the current time. That is, the processing circuitry may check whether the current time is within a predetermined interval associated with a prayer. For example, when the prayer mat 100 is turned ON, the processing circuitry may determine the current time. When the current time is between 4 am to 6 am, the processing circuitry may determine that the prayer is “Fajr” and thus 2 bows are required. The processing circuitry may then compare the number of bows performed with the required number of bows associated with the prayer time. In response to determining that the count is larger than the required number of bows, the prayer mat 100 may be turned off.

Table 1 shows an exemplary setting for prayer time detection. The table may be stored in a memory. The time intervals shown in table 1 are exemplary time intervals. The time interval values may depend on the location of the user and the current date as would be understood by one of ordinary skill in the art.

TABLE 1
Exemplary prayer times with corresponding required number of bows

| Prayer | Time interval | Required number of bows |
|---|---|---|
| “Fajr” | 4 am-6 am | 2 |
| “Zuhr” | 12 pm-2 pm | 4 |
| “Asr” | 3 pm-5 pm | 4 |
| “Maghrib” | 5 pm-8 pm | 3 |
| “Isha” | 9 pm-10 pm | 4 |

The microcontroller may be an Arduino board, a Raspberry Pi, a Beagle bone or the like. The Arduino board is a single board microcontroller.

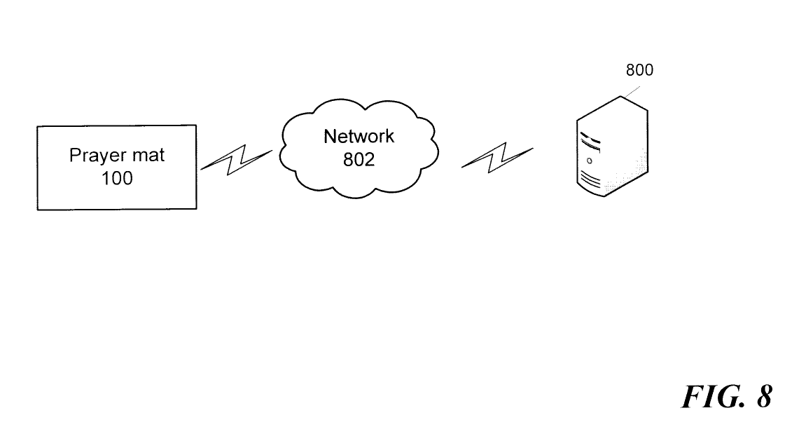

FIG. 8 is a schematic of a bow counting system according to one example. In one embodiment, the bow counting system may include communication circuitry to connect to a computer 800 via a network 802. The network 802 is any network that allows the computer 800 and the prayer mat 100 to communicate data with each other such as a Wide Area Network, Local Area Network, or the Internet. The bow counting system may connect to the computer 800 to download prayer times or the required number of bows. The bow counting system may also upload to the computer 800 a user log.

In one embodiment, the processing circuitry may store the user log in the memory. The user log may contain the number of bows performed and the time when the bows have been performed. The user log may also store a status. The status may indicate whether the predetermined number of bows associated with the prayer time are performed by the user. The processing circuitry compares the predetermined number with the bow count detected by the tactile sensor. The user log may be used by a guardian, a parent or a caregiver to check whether the user is complying with the predetermined number of bows. In one embodiment, the memory may be a USB flash drive. The USB flash drive is removable from the prayer mat 100. The processing circuitry may also compute a percentage of correct prayer performed so that the caregiver may check whether an improvement is made by the learner. The percentage may also be used to diagnose a deterioration in the mental health of the user when the prayer mat 100 is used by an elderly.

In one embodiment, the processing circuitry may generate an alert message when the predetermined number of bows is not performed by the user. The alert message may be sent via the network 802 to a caregiver.

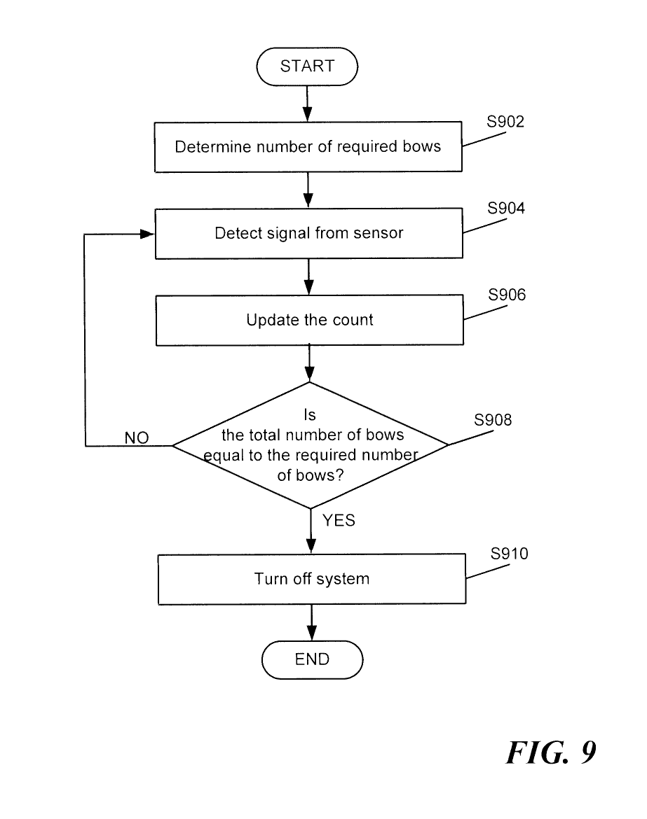

FIG. 9 is a flow chart that shows the operation of the bow counting system according to one example. At step S902, the processing circuitry may determine the number of required bows based on a current date and time. At step S904, the processing circuitry may check whether an output signal is detected. The output signal is generated and sent by the tactile sensor 200 to the processing circuitry. At step S906, the processing circuitry may check whether the output signal is a valid signal. In one embodiment, the processing circuitry may check whether the output signal is valid by comparing the voltage to the predetermined threshold. In response to determining that the output signal is valid, the count is updated by an incremental value. At step S908, the processing circuitry compares the count with the required number of bows. In response to determining that the count is equal to the required number of bows, the system is turned off to conserve battery power at step S910. In response to determining that the count is not equal to the required number of bows, the flows goes back to step S904.

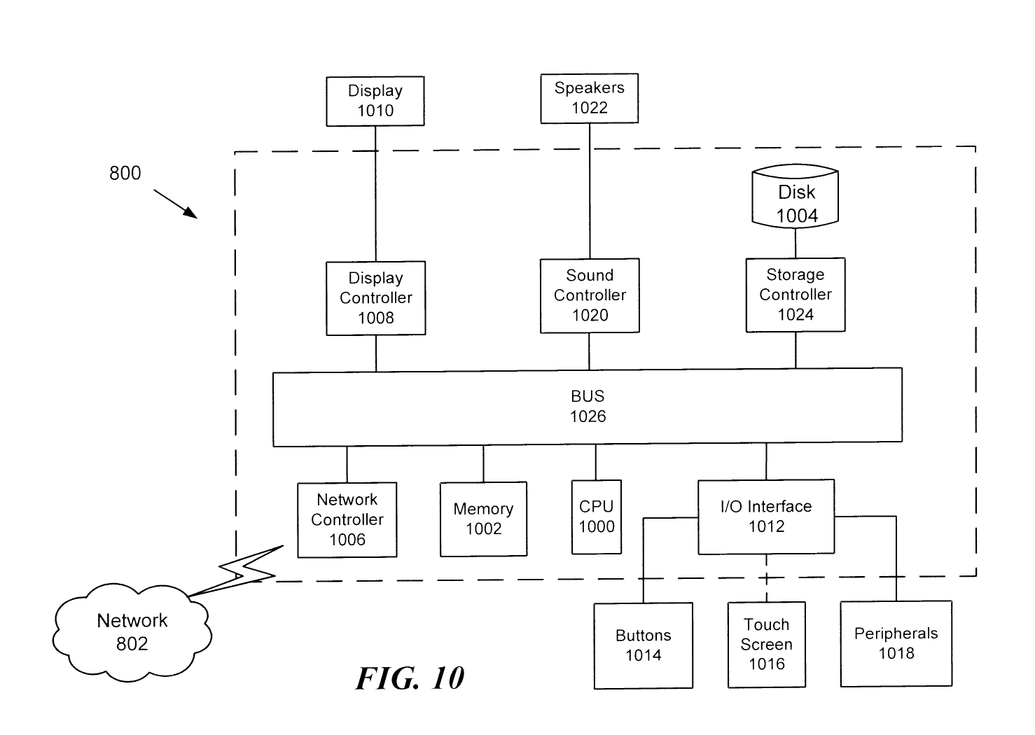

Next, a hardware description of the computer 800 according to exemplary embodiments is described with reference to FIG. 10. In FIG. 10, the computer 800 includes a CPU 1000 which performs the processes described above/below. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 800 communicates, such as a server or computer.

Further, the claimed advancements may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

The hardware elements in order to achieve the computer 800 may be realized by various circuitry elements, known to those skilled in the art. For example, CPU 800 may be a Xenon or Core processor from Intel of America or an Opteron processor from AMD of America, or may be other processor types that would be recognized by one of ordinary skill in the art. Alternatively, the CPU 800 may be implemented on an FPGA, ASIC, PLD or using discrete logic circuits, as one of ordinary skill in the art would recognize. Further, CPU 800 may be implemented as multiple processors cooperatively working in parallel to perform the instructions of the inventive processes described above.

The computer 800 in FIG. 10 also includes a network controller 1006, such as an Intel Ethernet PRO network interface card from Intel Corporation of America, for interfacing with network 802. As can be appreciated, the network 802 can be a public network, such as the Internet, or a private network such as an LAN or WAN network, or any combination thereof and can also include PSTN or ISDN sub-networks. The network 802 can also be wired, such as an Ethernet network, or can be wireless such as a cellular network including EDGE, 3G and 4G wireless cellular systems. The wireless network can also be WiFi, Bluetooth, or any other wireless form of communication that is known.

The computer 800 further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the computer 800, such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the computer 800. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

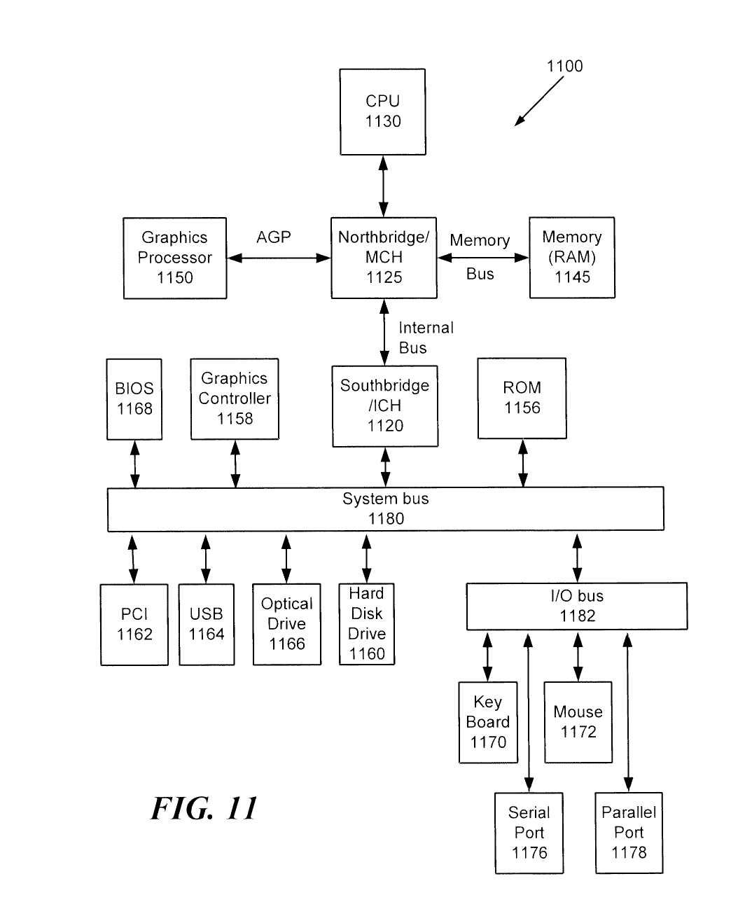

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system, according to certain embodiments, for monitoring the number of bows performed during prayers. The data processing system is an example of a computer in which specific code or instructions implementing the processes of the illustrative embodiments may be located to create a particular machine for implementing the above-noted process.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU Processing unit 1130 may contain one or more processors and even may be implemented using one or more heterogeneous processor systems.

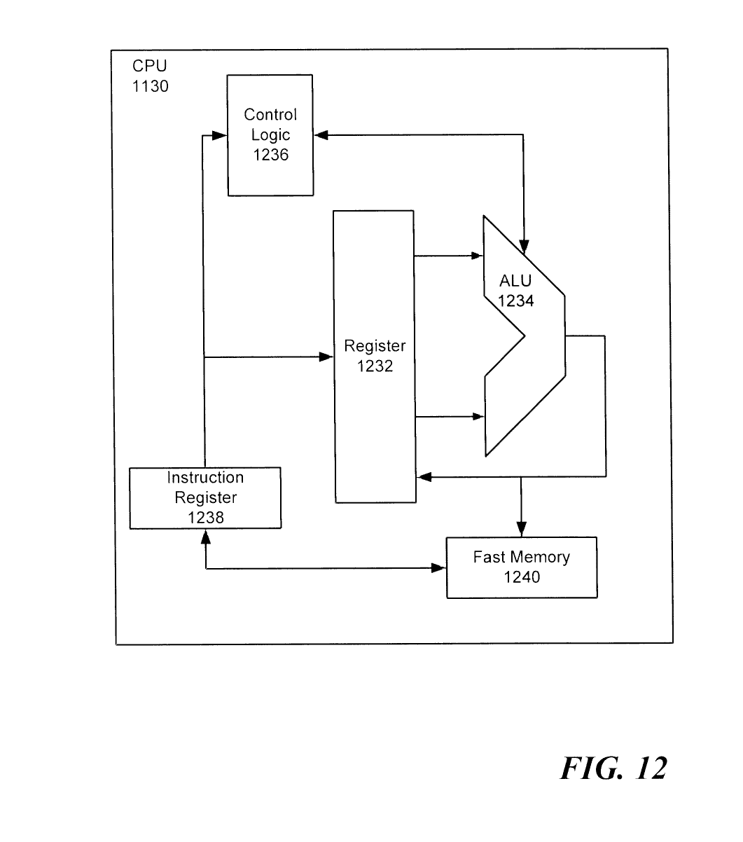

For example, FIG. 12 shows one implementation of CPU 1130. In one implementation, the instruction register 1238 retrieves instructions from the fast memory 1240. At least part of these instructions are fetched from the instruction register 1238 by the control logic 1236 and interpreted according to the instruction set architecture of the CPU 1130. Part of the instructions can also be directed to the register 1232. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a very large instruction word architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus 1180 to an I/O Bus 1182, a read only memory (ROM) 1156, universal serial bus (USB) port 1164, a flash binary input/output system (BIOS) 1168, and a graphics controller 1158. PCI/PCIe devices can also be coupled to SB/ICH 1120 through a PCI bus 1162.

The PCI devices may include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation, the I/O bus 1182 can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus 1180 through the I/O bus 1182. Other peripherals and devices that can be connected to the SB/ICH 1120 using a mass storage controller such as SATA or PATA , an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in a network. The above-described hardware description is a non-limiting example of corresponding structure for performing the functionality described herein.

The hardware description above, exemplified by any one of the structure examples shown in FIG. 10 or 11 constitutes or includes specialized corresponding structure that is programmed or configured to perform the algorithm shown in FIG. 9. For example, the algorithm shown in FIG. 9 may be completely performed by the circuitry included in the chipset as shown in FIG. 11.

A prayer mat which includes the features in the foregoing description provides numerous advantages to users. In particular, the prayer mat fulfills the need of Muslims with memory loss issues to become independent and perform their daily prayers in a correct manner. It provides the feeling of fulfillment that a worshiper seeks when trying their best to perform their daily prayers. The worshiper may remain focused on performing the actual prayer rather than feeling guilty for forgetting the number of bows left in the prayer.

In addition, the prayer mat described herein does not require additional actions by the user. The prayer mat 100 starts automatically counting the number of bows when pressure is applied on the tactile sensor. The prayer mat has a low cost. The prayer mat may be also used by newly converted Muslims or children learning how to pray.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A prayer mat, the prayer mat comprising:
a tactile sensor secured to a surface of the prayer mat in proximity to the middle of the prayer mat configured to generate an output signal in response to detecting a pressure applied from knees of a user;
a bow count indicator configured to generate a visible signal;
a memory; and
processing circuitry configured to
receive the output signal from the tactile sensor,
determine whether the output signal is valid by comparing the output signal to a predetermined signal level stored in the memory,
update a count in response to determining that the output signal is valid, and
activate the bow count indicator.

2. The prayer mat of claim 1, wherein the processing circuitry includes four D flip-flops connected to the tactile sensor.

3. The prayer mat of claim 1, wherein the tactile sensor includes two conductive fabrics separated by an air gap.

4. The prayer mat of claim 1, wherein the tactile sensor is secured to the surface of the prayer mat at a third of the distance from an upper short edge of the prayer mat.

5. The prayer mat of claim 1, wherein the output signal is a function of the pressure applied by the knees of the user.

6. The prayer mat of claim 1, wherein the tactile sensor is secured to a lower surface of the prayer mat.

7. The prayer mat of claim 1, wherein the tactile sensor is secured in between a lower surface and a top surface of the prayer mat.

8. The prayer mat of claim 1, wherein the processing circuitry is further configured to:
determine a required number of bows based on a current time.

9. The prayer mat of claim 1, wherein the processing circuitry is further configured to:
determine a required number of bows based on a current time, a current date, and a location of the user, wherein the location of the user is detected using location detection circuitry.

10. The prayer mat of claim 1, wherein the bow count indicator includes at least four light emitting diodes.

11. The prayer mat of claim 1, wherein the bow count indicator includes a one-digit display.

12. A bow counting device, the device comprising:
a tactile sensor configured to generate an output signal in response to detecting a pressure applied from knees of a user;
a bow count indicator configured to generate a visible signal;
a memory; and
processing circuitry configured to
receive the output signal from the tactile sensor,
determine whether the output signal is valid by comparing the output signal to a predetermined signal level stored in the memory,
update a count in response to determining that the output signal is valid, and
activate the bow count indicator.

13. A bow counting method, the method comprising:
determining, by processing circuitry, a required number of bows based on a current date and time;
receiving an output signal from a tactile sensor in response to detecting pressure applied from knees of a user;
updating, using the processing circuitry, a count in response to receiving the output signal from the tactile sensor;
activating a bow count indicator that shows the count;
comparing the count with the required number of bows; and
generating a visual signal to the user when the count is equal to the required number of bows.
